(19) United States
(12) Patent Application Publication
(10) Pub. No.: US 2009/0198628 A1
(43) Pub. Date: Aug. 6, 2009

(54) METHOD FOR PRICING AND PROCESSING DISTRIBUTED TASKS

(76) Inventor: Paul Stadler, (US)

Correspondence Address: PAUL STADLER, 500 HEMLOCK LANE, NAZARETH, PA, 18064, US

(21) Appl. No.: 12/024,202

(22) Filed: Feb. 1, 2008

(51) Int. Cl. G06Q 30/00; G06Q 10/00; G06Q 40/00

(52) U.S. Cl. 705/36 R; 705/1; 705/37

(57) ABSTRACT

A system is described for interchange of problems and solutions by a human or computer which system has the capability to use market forces to determine a price of the solutions. The system comprises a client subsystem for solving problems, a client subsystem for submitting problems, an API by which to access the centralized exchange system, data storage, an administration subsystem, and a primary processing subsystem.

### BACKGROUND OF THE INVENTION

1. Field of Invention

The present invention pertains to the field of distributed computing. More specifically, the present invention relates to further enhancement and optimization of existing methods of hybrid human-computer distributed networking and computing systems.

2. Description of the Related Art

While there are numerous methods for employing computers to solve complex problems, there remains a problem set that can not be efficiently and accurately processed by computers and machine algorithms. Consider this set of problems and its intersection with the set of problems which humans may be capable of solving. The present invention is directed to facilitating the procuring of solutions to such problems.

The need for involving the human in many types of tasks has been recognized in the past. For example, Amazon Technologies, Inc. has developed a system referred to as the “Mechanical Turk” (U.S. Pat. No. 7,197,459). Companies such as People Force also appear to have developed a related technology. None of these systems optimizes for efficiency and empowerment of buyer and seller, or employs a market driven system of pricing and distribution.

### SUMMARY OF THE INVENTION

A system by which sellers of solutions and parties with humanly solvable problems can transact using a network such as the Internet. This system ensures efficient facilitation of problem solutions through the use of market forces. Both parties (buyers and sellers) involved in a transaction are placed in spreads to affect competition and hence fair prices.

Further to this innovation, a method of categorization and qualification are introduced to enable the above capability. Thus, users have the ability to interact with this system in a similar manner to a stock (equity) exchange.

Thus, a first aspect of the invention is a method for facilitating the completion of arbitrary tasks, the method comprising: receiving, in a central control server, one or more sets of problem data; storing said sets of problem data for later use in a computer-readable storage medium coupled to said central control server; distributing one or more sets of problem data to be solved to one or more client applications; receiving from said client applications one or more solutions to said one or more sets of problem data to be solved; storing said solutions for later use in a computer-readable storage medium coupled to said central control server.

Another aspect of the invention comprises: receiving, in said central control server, ask prices for at least a portion of said sets of problem data; storing said ask prices in a computer-readable medium coupled to said central control server; and determining whether to execute a transaction between a buyer and a seller of a solution for one of said sets of problem data, based on said ask prices.

Another aspect of the invention comprises: receiving, in said central control server, bid prices for at least a portion of said sets of problem data; storing said bid prices in a computer-readable medium coupled to said central control server; and determining whether to execute a transaction between a buyer and a seller of a solution for one of said sets of problem data, based on said bid prices and said ask prices.

Another aspect of the invention comprises: determining a bid price for at least one of said sets of problem data based on a current market price for said one of said sets of problem data.

In another aspect of the invention, said determining whether to execute a transaction further comprises determining whether a first ask price is less than a first bid price, said first ask price and said first bid price being associated with the same one of said sets of problem data.

In another aspect of the invention, said determining whether to execute a transaction further comprises determining whether a first ask price is less than a first bid price, said first ask price and said first bid price being associated with the same one of said sets of problem data.

In another aspect of the invention, one or more groups of substantially similar sets of problem data are associated with categories; and said determining whether to execute a transaction further comprises determining whether a first ask price is less than a first current market price, said first ask price being associated with a first one of said sets of problem data, said first current market price being associated with a category of said categories associated with said first one of said sets of problem data.

In another aspect of the invention, one or more groups of substantially similar sets of problem data are associated with categories.

In another aspect of the invention, all of said sets of problem data associated with one of said categories have the same price.

In another aspect of the invention, access to said categories by a user is restricted based on qualification attributes of said user.

Another aspect of the invention comprises: sending updates to said client applications including changes in said bid prices and said ask prices assigned to said sets of problem data.

Another aspect of the invention is a system for facilitating the completion of arbitrary tasks, the system comprising: a computer-readable storage medium which stores sets of problem data for later use; a central control server, coupled to said computer-readable storage medium, which receives one or more sets of problem data, and distributes one or more sets of problem data to be solved to one or more client applications; and one or more client applications which receive said one or more sets of problem data to be solved from said central control server, and provide one or more solutions to said one or more sets of problem data to be solved to said central control server.

Another aspect of the invention is a server for facilitating the completion of arbitrary tasks, comprising: a computer-readable storage medium which stores one or more sets of problem data and one or more solutions to said one or more sets of problem data to be solved for later use; and a client interface which receives said one or more sets of problem data from a client application, distributes one or more sets of problem data to be solved to one or more client applications, and receives from said client applications said one or more solutions to said one or more sets of problem data to be solved;

Another aspect of the invention comprises: a market management unit which determines whether to execute a transaction between a buyer and a seller of a solution for one of said sets of problem data, based on bid prices and ask prices; wherein said client interface receives, in said server, said bid prices and said ask prices for at least a portion of said sets of problem data; and said computer-readable storage medium stores said bid prices and said ask prices for later use.

### BRIEF DESCRIPTION OF THE DRAWINGS

The above and other features and aspects of the present invention will become more apparent by describing in detail exemplary embodiments thereof with reference to the attached drawings in which:

FIG. 1 illustrates an overview of a system according to an exemplary embodiment of the invention;

FIG. 2 illustrates a process used by the market manager to evaluate when contracts should be formed in an exemplary embodiment of the invention;

### DETAILED DESCRIPTION OF EXEMPLARY EMBODIMENTS

In the following description, various aspects of the present invention will be described. However, it will be apparent to those skilled in the art that the present invention may be practiced with only some or all aspects of the present invention. For purposes of explanation, specific numbers, materials and configurations are set forth in order to provide a thorough understanding of the present invention. However, it will also be apparent to one skilled in the art that the present invention may be practiced without the specific details. In other instances, well known features are omitted or simplified in order not to obscure the present invention.

Parts of the description will be presented using terminology commonly employed by those skilled in the art to convey the substance of their work to others skilled in the art, such as node, server, client, and so forth. However, some terms may be specifically defined to have a different meaning from their commonly accepted meaning in the art.

In particular, the terms “server” and “database” are not necessarily limited to describing a single machine or computer, as one skilled in the art would easily discern common methods of distributing certain functions among multiple machines or computers, for example, for purposes of load balancing.

The order of description should not be construed so as to imply that these operations are necessarily performed in the order they are presented, or are order-dependent. Repeated usage of the phrase “in one embodiment” does not necessarily refer to the same embodiment, although it may.

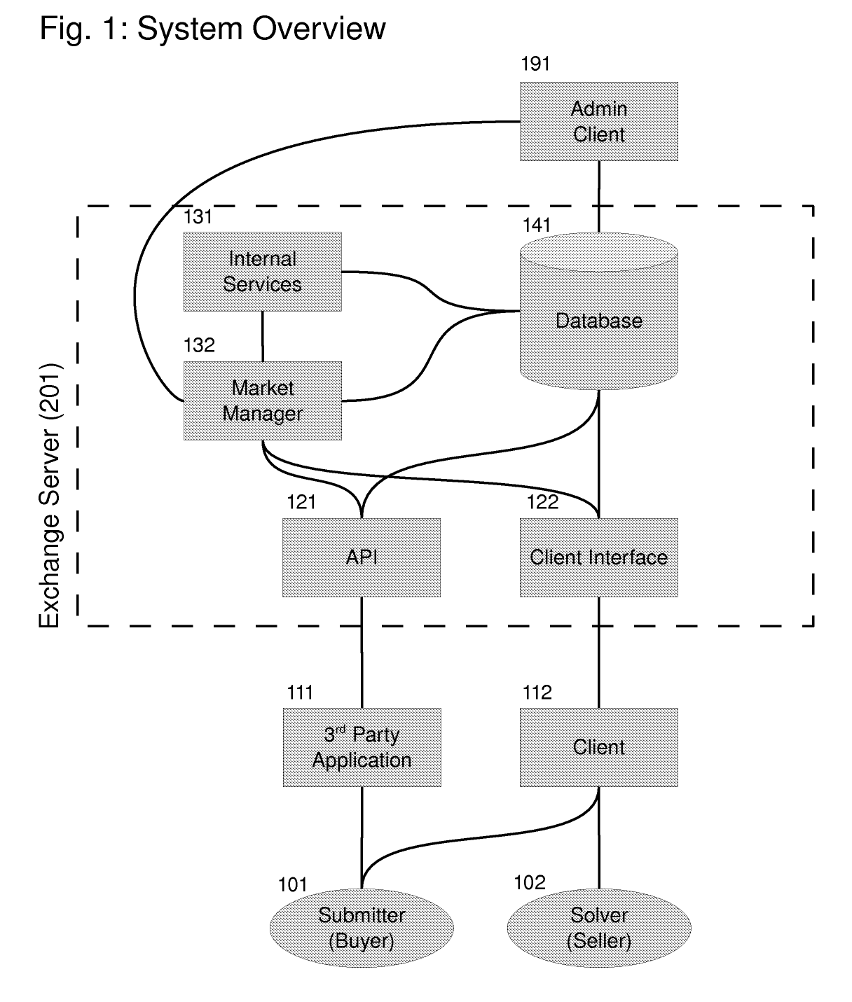

Referring now to FIG. 1, FIG. 1 shows an overview of an exemplary embodiment including a buyer 101 and a seller 102 of a solution to a problem or task, and the mechanism by which they transact. The system acts in such a way as to bring a buyer 101 and a seller 102 together to form contracts for work and to relay problem and solution data between the buyer 101 and the seller 102.

In the described exemplary embodiments, a problem refers to digital data that represents and describes a human task that can be solved via a client 112. This data may consist of images, text, code, or other forms of data that are required to adequately communicate the problem to a solver 102. In this context, a problem refers to a specific problem that a human is likely to be able to solve, for example: audio to text translation, survey questions, language translation, object recognition, or other such problems. The preceding list is merely exemplary in nature, and is not intended to limit the scope or types of problems which may be handled by the following exemplary embodiments, or which may be solved by a solver 102. Problem information may include, but is not limited to: title, description, order type, price, problem data, feeds, or any other information useful in construing a problem to a solver 102.

In the described exemplary embodiments, a feed refers to a group or category of related problems such that a solver 102 can ask a price for any problem on the feed and feel assured that there exists a “reasonable homogeneity” of problems on the feed. Thus, if a solver 102 is able to solve one problem on a feed, the solver 102 is likely to be able to solve any problem on the feed.

The operation of the exemplary embodiment shown in FIG. 1 is as follows: A submitter 101 submits a problem to the system by one of two mechanisms. The first mechanism is a client 112 which interacts with the exchange 201 to submit a problem. The client 112 interacts with the client interface 122 to transfer problem information to the exchange 201. The client 112 may interact with the client interface 122 via a network, such as the internet, a wireless network, a cellular network, etc., via a direct communications link, such as a serial interface, a parallel interface, etc., or via other means of communication as would be generally known to those skilled in the art.

The client interface 112 coordinates with the market manager 132 to place the problem information in the database 141. When problem data is successfully submitted to the exchange 201, this new problem data is transferred to all submitters 101 and solvers 102 that subscribe to a feed associated with the submitted problem data.

The second mechanism for problem submission is the API 121. The API performs the same function as the client interface 122 in this respect, but in a manner that allows the submitter 101 to create or use a 3rd party application 111 to submit problems.

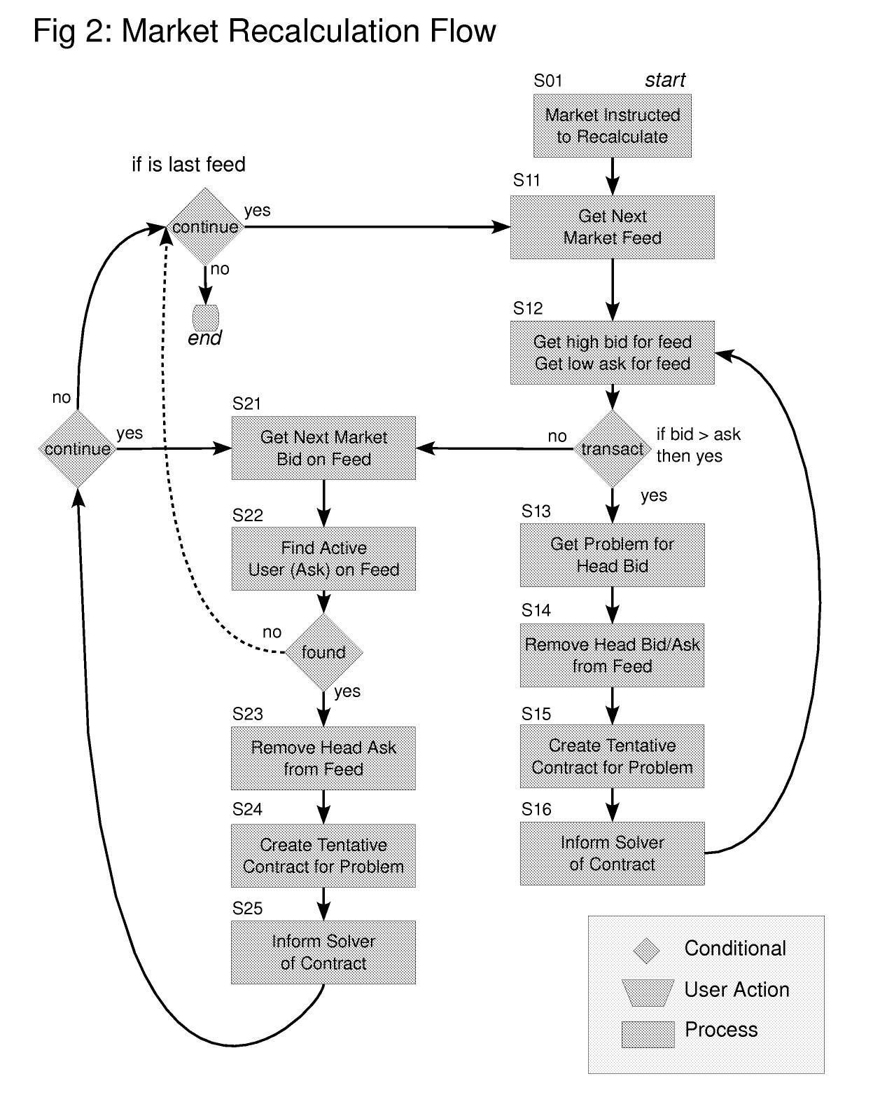

Once problem data has been successfully submitted to the exchange 201, the market manager 132 makes a determination of action regarding the problem. The problem can have been submitted with at least two different types of order. An order type of “limit” indicates that submitter 101 is willing to pay a specified price for a solution to the problem. An order type of “market” indicates that submitter 101 is willing to pay the lowest asking price on the problem's feed. Other types of orders are also possible; the description of limit and market orders herein is not intended to limit the types of orders which may be supported. The process the market manager uses to assign contracts is illustrated in FIG. 2.

Users of the system, such as the buyer 101 and seller 102, are given access to feeds via qualifications. A user is “qualified” or “not qualified” to access a feed. All activity regarding feeds is predicated by a users qualification to access the feed. Feeds may also have a minimum rating for further limiting access.

Upon problem submission, the problem and associated bid are stored in the database 141. If the order type is “market”, the market manager 132 will create a tentative contract that indicates the problem is to be solved by the lowest priced solver 102 on the associated feed (S24). Once a contract is formed, the associated problem and the associated solver 102 are removed from active trading (S23). Tentative contract information is stored in database 141 and transmitted to the solver 102 (S25). The solver 102 may then accept or reject the contract via the client 112. If the solver 102 accepts the tentative contract, it is considered a “firm” contract and a solution is expected to be provided by solver 102. If solver 102 rejects the tentative contract or a predetermined amount of time elapses, the problem resumes active trading, the solver 102 is removed from active trading, and the contract is rejected and stored in the database 141 as a “rejected” contract. This mechanism ensures that active users are present on the exchange 201 and inactive users are not superfluously listed as problem solving resources on the exchange 201.

Upon problem submission, the problem and associated bid are stored in the database 141. If these actions have changed the “spread” of the associated feed, new feed information is transmitted to all online users. A spread refers to information indicating the range of bids and asks, for example, the lowest ask and highest bid, and/or the difference between the lowest ask and highest bid. If the order type is “limit”, the market manager 132 will determine if there is an asking price (a price specified by a solver 102 for which he is willing to be paid to solve a problem on a specified feed) that is less than the bid price specified during problem submission (S12). If there is not, then the market manager 132 will wait. If the lowest asking price is less than the specified bid amount, then a tentative contract is formed (S15). At this time, the same process for accepting and rejecting of market orders takes place between the solver 102 and the exchange 201 (S21).

The market manager 132 evaluates changes in the exchange 201, specifically, changes in the database 141, to determine if a new action should be taken. The function of automatically forming contracts based on order by solvers and submitters is represented in FIG. 2. In the case of updates to the database 141, the market manager 132 transmits relevant information, such as prices associated with current problems, to the solver 102 and the submitter 101 via the client 112 and the third party application 111. The market manager 132 evaluates feed spreads to determine if contracts should be formed.

The solver 102 is associated with a feed when the solver 102 sets an asking price on a feed via client 112. This data is stored in the database 141 by the market manager 132.

Solver 102 may at this time find a problem on a feed that he wishes to solve. In this case, he may create a contract directly using the client 112 and the client interface 122. Once a contract is formed, solver 102 is expected to solve the associated problem.

Upon formation of a contract, the solver 102 is able to display problem data in his client 112 in order to solve the problem. Actions required to solve the problem are dependent on the specific problem that the solver 102 has downloaded. For instance, if the problem is for translation of text, the solver 102 must enter translated text for the displayed text into a text box displayed in client 112. When the solver 102 completes a solution to the problem, the solver 102 submits the solution to the exchange 201 via the client 112. The client interface 122 stores the solution in the database 141 and informs the submitter 101 that a solution to the problem is available. If, during problem submission, the submitter 101 specified an action to be performed after the solution has been submitted, an action may be performed such as emailing the solution to a specified recipient, or sending the solution via a network to a specified destination. Post-submission network communications permit autonomous interaction with the API 121.

After submission of a solution, the submitter 101 may optionally provide feedback regarding the solution provided by the solver 102. Feedback from the submitter 101 may be provided via the client 112 and is stored in database 141. The submitter 101 can thereby influence rating information associated with the solver 102. The feedback information may include a comment, a rating, and further similar information. The rating information may be used to judge the accuracy of each user's solutions, and may be used to restrict or regulate users' access to various feeds.

What is claimed is:

1. A method for facilitating the completion of arbitrary tasks, the method comprising:
receiving, in a central control server, one or more sets of problem data;
storing said sets of problem data for later use in a computer-readable storage medium coupled to said central control server;
distributing one or more sets of problem data to be solved to one or more client applications;
receiving from said client applications one or more solutions to said one or more sets of problem data to be solved; and
storing said solutions for later use in a computer-readable storage medium coupled to said central control server.

2. The method of claim 1, further comprising:
receiving, in said central control server, ask prices for at least a portion of said sets of problem data;
storing said ask prices in a computer-readable medium coupled to said central control server; and
determining whether to execute a transaction between a buyer and a seller of a solution for one of said sets of problem data, based on said ask prices.

3. The method of claim 2, further comprising:
receiving, in said central control server, bid prices for at least a portion of said sets of problem data;
storing said bid prices in a computer-readable medium coupled to said central control server; and
determining whether to execute a transaction between a buyer and a seller of a solution for one of said sets of problem data, based on said bid prices and said ask prices.

4. The method of claim 2, further comprising:
determining a bid price for at least one of said sets of problem data based on a current market price for said one of said sets of problem data.

5. The method of claim 3, wherein said determining whether to execute a transaction further comprises determining whether a first ask price is less than a first bid price, said first ask price and said first bid price being associated with the same one of said sets of problem data.

6. The method of claim 4, wherein said determining whether to execute a transaction further comprises determining whether a first ask price is less than a first bid price, said first ask price and said first bid price being associated with the same one of said sets of problem data.

7. The method of claim 2, wherein:
one or more groups of substantially similar sets of problem data are associated with categories; and
said determining whether to execute a transaction further comprises determining whether a first ask price is less than a first current market price, said first ask price being associated with a first one of said sets of problem data, said first current market price being associated with a category of said categories associated with said first one of said sets of problem data.

8. The method of claim 1, wherein one or more groups of substantially similar sets of problem data are associated with categories.

9. The method of claim 8, wherein all of said sets of problem data associated with one of said categories have the same price.

10. The method of claim 8, wherein access to said categories by a user is restricted based on qualification attributes of said user.

11. The method of claim 2, further comprising sending updates to said client applications including changes in said bid prices and said ask prices assigned to said sets of problem data.

12. A system for facilitating the completion of arbitrary tasks, the system comprising:
a computer-readable storage medium which stores sets of problem data for later use;
a central control server, coupled to said computer-readable storage medium, which receives one or more sets of problem data, and distributes one or more sets of problem data to be solved to one or more client applications; and
one or more client applications which receive said one or more sets of problem data to be solved from said central control server, and provide one or more solutions to said one or more sets of problem data to be solved to said central control server.

13. A server for facilitating the completion of arbitrary tasks, comprising:
a computer-readable storage medium which stores one or more sets of problem data and one or more solutions to said one or more sets of problem data to be solved for later use; and
a client interface which receives said one or more sets of problem data from a client application, distributes one or more sets of problem data to be solved to one or more client applications, and receives from said client applications said one or more solutions to said one or more sets of problem data to be solved;

14. The server of claim 13, further comprising:
a market management unit which determines whether to execute a transaction between a buyer and a seller of a solution for one of said sets of problem data, based on bid prices and ask prices;
wherein said client interface receives, in said server, said bid prices and said ask prices for at least a portion of said sets of problem data; and
said computer-readable storage medium stores said bid prices and said ask prices for later use.
